(19) United States
(12) Patent Application Publication
(10) Pub. No.: US 2014/0032605 A1
(43) Pub. Date: Jan. 30, 2014

(54) SELECTION OF DATA PATHS

(71) Applicants: Burcu Aydin, Mountain View, CA (US); Kemal Guler, San Jose, CA (US); Carlos Alejandro Alfaro-Montufar, Mexico City (MX); Carlos Enrique Valencia Oleta, Tlalpan (MX)

(72) Inventors: Burcu Aydin, Mountain View, CA (US); Kemal Guler, San Jose, CA (US); Carlos Alejandro Alfaro-Montufar, Mexico City (MX); Carlos Enrique Valencia Oleta, Tlalpan (MX)

(21) Appl. No.: 13/560,435

(22) Filed: Jul. 27, 2012

(51) Int. Cl. G06F 17/30

(52) U.S. Cl. 707/797; 707/E17.012

(57) ABSTRACT

Systems, methods, and computer-readable and executable instructions are provided for selecting data paths. Selecting data paths can include creating a support data tree structure from a number of data trees within a data set. In addition, selecting data paths can include removing a number of paths from the support data tree based on a number of evaluations of each of a number of nodes within the support data tree. Furthermore, selecting data paths can include selecting a desired set of paths based on a desired number of removed paths and an associated number of evaluations of the support data tree.

### BACKGROUND

Statistical data can be represented by a tree shaped object. Tree shaped data objects can represent various data in a number of different areas. For example, tree shaped data objects can be utilized in manufacturing, biological applications, computer science, decision science, and optimization; among other areas.

### BRIEF DESCRIPTION OF THE DRAWINGS

FIG. 1 is a flow chart illustrating an example of a method for selecting data paths according to the present disclosure.

FIG. 2 is a diagram illustrating an example of a visual representation for calculating a projection value for a data tree according to the present disclosure.

FIG. 3 is a diagram illustrating an example of a visual representation for selecting data paths according to the present disclosure.

FIG. 4 is a diagram illustrating an example of a computing device according to the present disclosure.

### DETAILED DESCRIPTION

A data tree can include a number of nodes connected to form a number of node paths, wherein one of the nodes is designated as a root node. Each individual node within the number of nodes can each represent a data point. The number of node paths can show a relationship between the number of nodes. For example, two nodes that are directly connected (e.g., connected with no nodes between the two nodes) can have a closer relationship compared to two nodes that are not directly connected (e.g., connected with a number of nodes connected between the two nodes).

A plurality of data trees can be collected as a data set. The plurality of data trees can be utilized to create a support data tree. The support data tree, as described further herein, can represent the plurality of data trees from the data set by aligning the plurality of data trees to corresponding nodes within the plurality of data trees. Corresponding nodes can include a number of nodes from a plurality of data sets and/or within the same data set that are in a common location. The number of nodes that are in the common location can include the number of nodes being the same data object.

The support data tree can be a rooted tree (e.g., a data tree with a number of levels of nodes where the node at the highest level contains a single node known as a root node).

Various types of data can be represented utilizing a tree shaped data model. For example, with product customization in a number of industries, a customer can make decisions regarding a number of features of the product. For each decision by the customer, a different set of features can become available. For example, if the customer makes a decision on a particular model, the number of color choices for the particular model can be different compared to a different model. In this example, each decision can represent a node on a particular level. After completion of the product customization, the number of nodes can be connected to form a data path and/or data tree. In this example, the data path and/or data tree can be considered a single data point. If a different customer went through the product customization, the different customer decisions can be connected to form a different data path and/or data tree.

In some examples of the present disclosure, the support data tree can be evaluated and reveal certain underlying structural properties of the plurality of data trees within a data set. By evaluating an influence (e.g., weight, numerical value) of each of a number of paths on the support data tree and removing a path of less influence compared to other paths (e.g., over a number of iterations), a set of desired set of paths (e.g., number of paths with a greatest influence, path with a relatively high frequency of occurrence within a particular data set, etc.) can be selected.

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

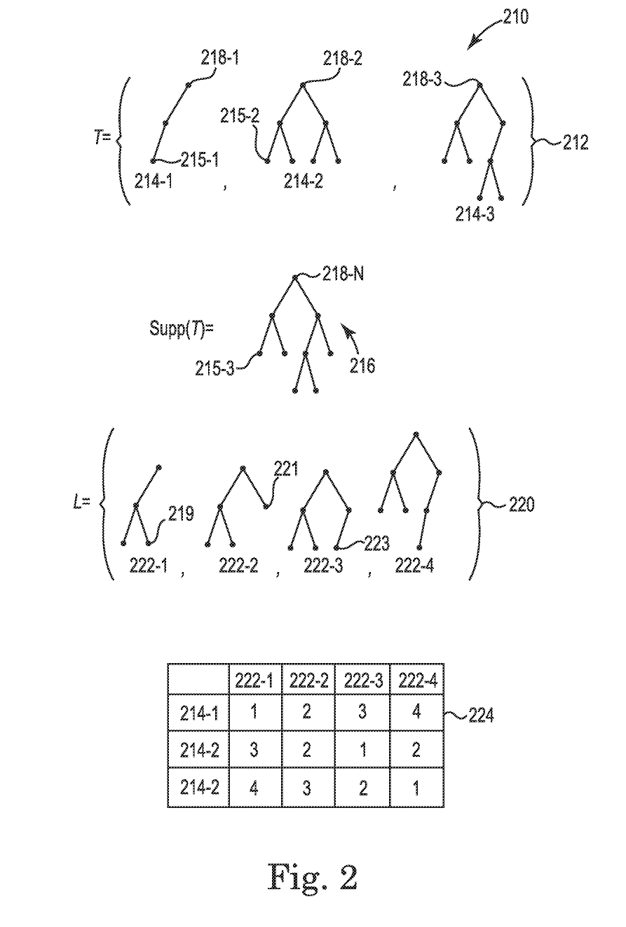

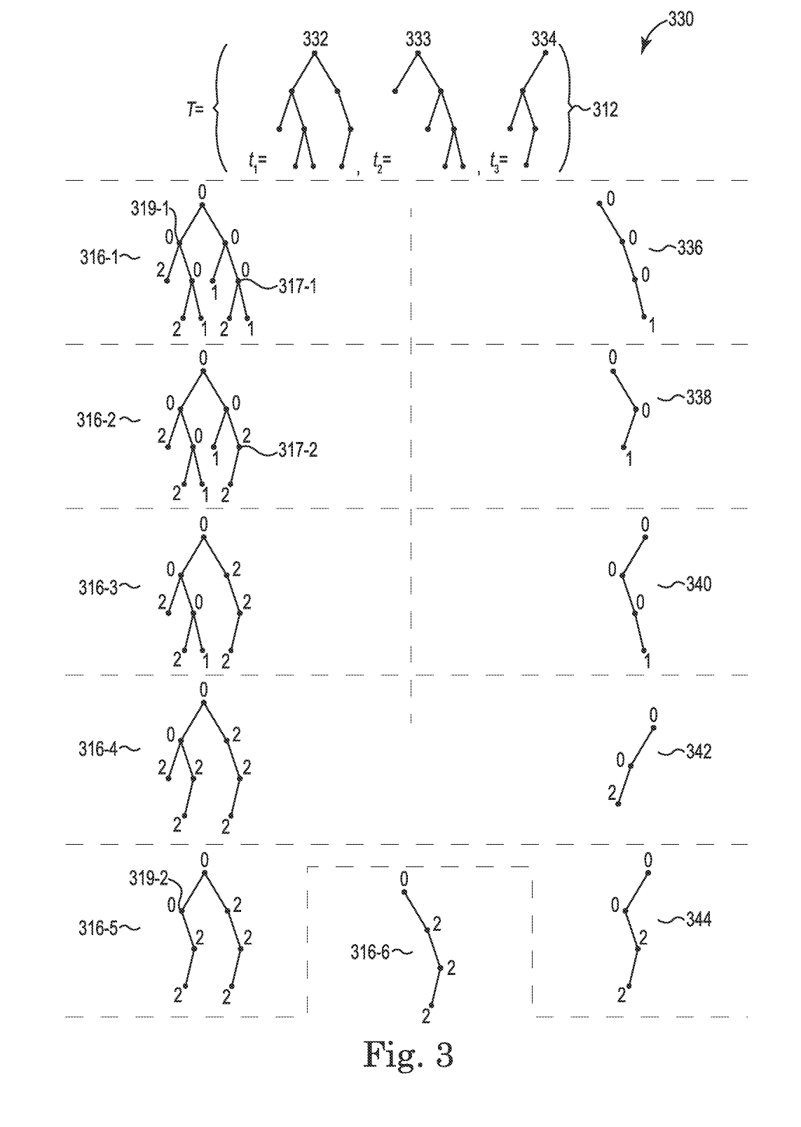

The figures herein follow a numbering convention in which the first digit or digits correspond to the drawing figure number and the remaining digits identify an element or component in the drawing. Similar elements or components between different figures may be identified by the use of similar digits. For example, 212 may reference element “12” in FIG. 2, and a similar element may be referenced as 312 in FIG. 3. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

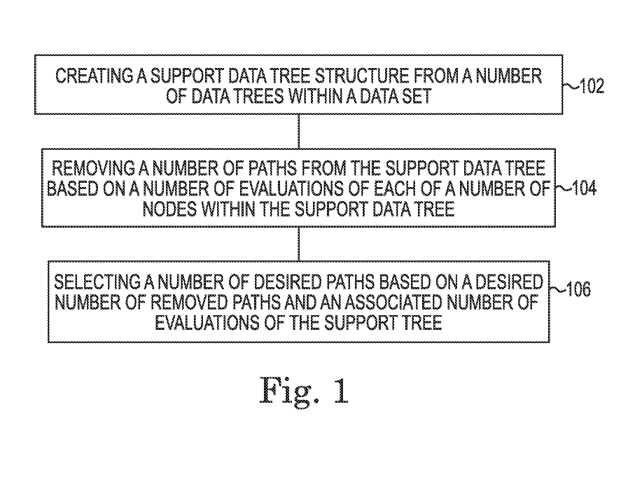

FIG. 1 is a flow chart illustrating an example of a method for selecting data paths according to the present disclosure. The data path that is selected can include a number of connected nodes from a support data tree structure (e.g., support data tree). The support data tree can be a rooted tree with a single root node. For example, the support data tree can include a number of levels that each consist of a number of nodes. Each level can be connected to a number of nodes in a different level (e.g., a higher level, a lower level, the single root node, etc.).

The root node can be a highest level node within the support data tree (e.g., connected to only one level, etc.). There can be a number of intermediate levels of nodes that can be located on lower levels compared to the root node (e.g., connected to a plurality of different level of nodes, connected to the root node and a different level of nodes, etc.). The intermediate level of nodes can be considered child nodes as described herein. There can also be a lowest level of nodes (e.g., leaf nodes, leaves, etc.). The lowest level of nodes can be nodes with no nodes connected on a lower level (e.g., connected to a node on a higher level, but not connected to a node on a lower level). The leaf nodes can be utilized as an end to a data path, where the start of the data path is a root node.

At 102 the support data tree structure is created from a number of data trees within a data set. The data trees within the data set can include a number of collected data sets in the form of data trees. Each data tree within the data set can be a rooted tree. Each data tree within the data set can also have a corresponding root node that is shared by each of the data trees within the data set. For example, a selected node (e.g., root node, etc.) for each data tree within the data set can represent a starting point of the data tree, wherein each data tree shares a common starting point. In some cases the data trees within the data set can be non-rooted trees. If the data trees within the data set are not rooted trees, a root node can be determined for each of the data trees within the data set.

The starting point can be selected as a node and or a tree where each tree line can start from a node within the starting point. For example, the root node and a first child of the root node can be considered the starting point of the tree line. As described further in reference to FIG. 2, an additional child can be added to each tree to create a new tree within the tree line. In this example, a node path can be extended by adding a child node. The node path can start at the starting point (e.g., root node and the first child of the root node) and end at the added child node. The number of nodes that are included in the starting point can have a designated weight of 0.

The number of data trees within the data set can be combined to create the support data tree. For example, the data trees within the data set can be combined by aligning and/or merging common node locations and adding non-common node locations to the support data tree. Aligning and/or merging the common node locations can create a support data tree where each node within the support data tree represents a number of node locations within the data set. As described herein, the common node locations can be common nodes and/or common data objects.

The root node for each data tree within the data set can be aligned and/or merged as the root node of the support data tree. For example, if the root node for each data tree within the data set corresponds to the same “starting point”, then the support data tree can include a single root node that corresponds to each of the root nodes of the data trees within the data set.

At 104 a number of paths are removed from the support data tree based on a number of evaluations of each of a number of nodes within the support data tree. The number of evaluations can include the weight value and/or the projection value. A number of paths can be removed based on the weight value and/or projection value for a particular path within the support data tree and the number of data trees within the data set. The paths within the support data tree can be evaluated based on each of the leaves (e.g., a node without a child node, a node not connected to a node on a lower level, etc.) of the support data tree.

The number of evaluations can be calculated by utilizing a number of equations to determine a data path with a lower amount of influence compared to other data paths within the data set. For example, a particular node within the support data tree can represent a larger number of corresponding nodes and/or weight within the data set compared to a different node within the support data tree. In another example, a first node within the support data tree can represent 10 nodes that correspond to a location (e.g., particular data object) of the first node and a second node within the support data tree can represent 5 nodes that correspond to a location (e.g., particular data object) of the second node.

The number of evaluations can also be calculated in reference to utilizing a projection value. The projection value, which is described further in reference to FIG. 2, can be determined based on a number of node differences (e.g., a distance) between a particular data tree within the data set and a tree line. The tree line can be a sequence of data trees where each data tree in the sequence includes a number of additional nodes (e.g., child nodes, leaves, etc.). The projection value can be utilized to determine a number of tree lines that carry a lower amount of variation compared to other tree lines within the support data tree. There can be a number of tree lines that carry the same amount of variation and a rule can be defined to determine a single tree line with a lowest amount of variation. The rule can include selecting a tree line from a particular side of the support data tree, among other rules that can select between a number of tree lines with the same amount of variation.

A numerical value can be assigned to each of the number of nodes within the support data tree. The numerical value can reflect the evaluations as described herein. A desired (e.g., lowest) numerical value for a particular data path within the support data tree can be removed. In some examples, a single data path is removed from the support data tree based on the number of evaluations (e.g., calculation of a numerical value for each node, evaluation of each node within a node path, total numerical value for each node within a node path, etc.).

As described further herein, a rule can be in place to determine what path to remove if there is a tie in the evaluation (e.g., the same total weight value for multiple data paths). For example, if a first and a second path both have a total path evaluation of 1, then the rule could determine that the first path be removed for being further in a particular direction of the support data tree (e.g., furthest right or furthest left, direction of the representation, etc.).

After the removal of a number of data paths (e.g., a single data path, etc.), a number of evaluations can be determined for each of the number of nodes for the support data tree. The number of evaluations after the removal of a number of data paths can be similar to the number of evaluations as described herein. For example, the distance (e.g., number of different nodes from a first tree to a second tree, etc.) of the projection between the number of paths within the support data tree can be utilized to determine a weight (e.g., numerical value, etc.) for each of the number of paths.

The support data tree can be evaluated after a removal of one of the number of paths (e.g., a numerical value calculated for each node, a total numerical value calculated for a node path, etc.). For example, the removal of one of the number of paths can change the structure of the support data tree and therefore, the evaluations and/or numerical value for each of the number of nodes could change. The number of evaluations can be performed for a predetermined number of path removals (e.g., N iterations). For example, as described herein, there can be a total of five paths removed (e.g., five iterations of the equation). In this example, a number of evaluations can be performed on the support data tree that remains after the removal of the path. The number of evaluations can utilize the same and/or similar equation to determine a weight and/or numerical value for each of the remaining nodes within the support data tree.

At 106 a desired set of paths is selected based on a desired number of removed paths and an associated number of evaluations of the support data tree. The desired set of paths can be determined based on a backward principal component (BCP) equation. The desired set of paths can be the result of N number of path removals (e.g., iterations of the equation) as described herein. Each path removal can include the removal of a path that has the least influence within the support data tree compared to the influence of the remaining paths within the support data tree. For example, it can be determined that a path that leads to a leaf that is the least frequent within the data set has the least influence compared to a different path that leads to a leaf that is more frequent within the data set.

The N number of path removals can be predetermined based on the amount of data found within data set and/or the number of nodes within the support data tree. The N number of path removals can also be predetermined based on the desired set of paths of the user. The N number of path removals can also be based on a predetermined amount of noise within a data set. That is, in some examples, the N number of path removals can leave a single desired path. In some examples, the N number of path removals can leave a plurality of node paths (e.g., desired set of node paths, data tree with N number of paths removed, etc.).

FIG. 2 is a diagram 210 illustrating an example of a visual representation for calculating a projection value for a data tree according to the present disclosure. The diagram 210 is a graphical representation of information of the domains accessed (or attempted to be accessed) by the hosts. However, “data tree,” as used herein, does not require that a physical or graphical representation (e.g., data tree, support data tree, etc.) of the information actually exists. Rather, such a diagram 210 can be represented as a data structure in a tangible medium (e.g., in memory of a computing device). Nevertheless, reference and discussion herein may be made to the graphical representation (e.g., data set, 212, support data tree 216, tree line 220, etc.), which can help the reader to visualize and understand a number of examples of the present disclosure.

The diagram 210 includes a data set 212 that includes a number of rooted data trees 214-1, 214-2, 214-3. The data set 212 can include collected data that is organized into the number of rooted data trees 214-1, 214-2, 214-3. Each of the number of rooted data trees 214-1, 214-2, 214-3 can include a root node 218-1, 218-2, 218-3 respectively. As described herein, the root node (e.g., 218-1, 218-2, 218-3) can be the only node on a highest level of a particular data tree (e.g., 214-1, 214-2, 214-3). The number of rooted data trees 214-1, 214-2, 214-3 can also include a number of nodes 215-1, 215-2 that are on a lower level and/or intermediate level of the rooted data trees 214-1, 214-2, 214-3. The number of rooted data trees 214-1, 214-2, 214-3 within the data set 212 can also include a number of corresponding nodes 215-1, 215-2. The number of corresponding nodes 215-1, 215-2 are each represented at the same location within data tree 214-1 and 214-2 respectively. The same location can refer to the same data object and/or the same node. For example, corresponding nodes 215-1 and 215-2 can be the same data object and/or the same node.

The diagram 210 also includes a support data tree 216. The support data tree 216 can be representation of the rooted data trees 214-1, 214-2, 214-3 within the data set 212. For example, each node within the support data can correspond to a node of the rooted data trees 214-1, 214-2, 214-3 in the data set 212. In another example, node 215-3 can correspond to node 215-1 and 215-2 within the data set 212. Furthermore, a root node 218-N of the support data tree 216 can correspond to all of the root nodes 218-1, 218-2, 218-3 within the data set 212. The support data tree 216 can be created by combining each of the rooted data trees 214-1, 214-2, 214-3 within the data set 212 into a single support data tree 216.

The rooted data trees 214-1, 214-2, 214-3 can be combined into the single support data tree 216 by representing each distinct node location within the data set 212 with a node within the support data tree 216. For example, node 215-1 and node 215-2 can represent a single distinct node location within the data set 212. The node location can be represented by the node 215-3 within the support data tree 216.

As described herein, the support data tree 216 can be a rooted tree (e.g., a tree with a root node 218-N). The support data tree 216 can be created from a number of rooted trees 214-1, 214-2, 214-3 within a data set 212. The support data tree 216 can represent each of the nodes of the number of rooted trees 214-1, 214-2, 214-3. For example, the node 215-1 within the rooted tree 214-1 is represented in the support data tree at node 215-3. Each node location is represented once on the support data tree 216. For example, the node 215-1 and the node 215-2 are both in the same node location (e.g., same position on the same level, same data object, same node, etc.). In this example, the node location for node 215-1 and node 215-2 are represented by the single node 215-3 within the support data tree 216.

A tree line 220, as described herein, can be represented starting with data tree 222-1 and an additional child node can be added to each of the subsequent tree in the tree line 220. For example, if the tree line 220 starts at data tree 222-1 and progresses to data tree 222-2, a child node 221 can be added to data tree 222-1 to create data tree 222-2. In another example, a child node 223 can be added to data tree 222-2 to create data tree 222-3.

Each of the number of data trees 214-1, 214-2, 214-3 within the data set 212 can be compared to each of the number of data trees 222-1, 222-2, . . . , 222-4 within the tree line 220 to determine a distance (e.g., total number of nodes that exist in one data tree, but not the other). For example, Table 224 shows the distance between each of the number of data trees 214-1, 214-2, 214-3 within the data set 212 and each of the number of trees 222-1, 222-2, . . . , 222-4 within the tree line 220. For example, the distance between data tree 214-1 and data tree 222-1 is 1 (e.g., one node is different between data tree 214-1 and data tree 222-1). In this example, the node that is different is node 219. Node 219 does not have a corresponding node in data tree 214-1.

Determining the distance between a number of data trees 214-1, 214-2, 214-3 within the data set 212 and the number of trees 222-1, 222-2, . . . , 222-4 within the tree line 220 can provide a projection value for each node within the support data tree 216. As described herein, the projection value can be utilized to determine a path within the support data tree 216 to remove. For example, the projection value can be utilized to calculate a weight of a number of paths within the support data tree and a path with a least amount of influence can be removed.

FIG. 3 is a diagram 330 illustrating an example of a visual representation for selecting data paths according to the present disclosure. The diagram 330 is a graphical representation of information of the domains accessed (or attempted to be accessed) by the hosts. However, “data tree,” as used herein, does not require that a physical or graphical representation (e.g., data tree, support data tree, data path, etc.) of the information actually exists. Rather, such a diagram 330 can be represented as a data structure in a tangible medium (e.g., in memory of a computing device). Nevertheless, reference and discussion herein may be made to the graphical representation (e.g., data set, 312, support data tree 316, data path 336, etc.), which can help the reader to visualize and understand a number of examples of the present disclosure.

The set of data paths that are selected can be the desired set of data paths as described further in reference to FIG. 1. A data set 312 can comprise a number of data trees 332, 333, 334. The number of data trees 332, 333, 334 can be utilized to create a support data tree 316-1 as described further in reference to FIG. 2. The diagram 330 can be utilized to determine a desired set of data paths by inputting a number of factors. The number of factors can include the data set 312, the starting point (e.g., root node and node 319-1), and/or a stopping criteria (e.g., N number of paths to remove, N number of evaluations, etc.).

The support data tree 316-1 created from a projection tree line of the number of data trees 332, 333, 334 within the data set 312 can be assigned a number of evaluations and/or numerical values for each of the number of nodes within the support data tree 316-1. The number of evaluations can be utilized to determine a numerical value (e.g., weight) for each of the number of nodes within the support data tree 316-1. In this example, a numerical value of 0 is determined for nodes that have two children (e.g., nodes that are connected to two other nodes on a lower level). In addition, nodes within the starting point (e.g., root node, 319-1, 319-2, etc.) also have a numerical value of 0. Nodes that do not have children (e.g., leaves) and/or have only one child can have a non-zero positive numerical value (e.g., 1, 2, 3, etc.) based on a weight function as described herein. The numerical value can be determined utilizing the number of evaluations and/or Equation 1 and Equation 2 described below.

A data path can be removed from the support data tree 316-1 based on a lowest value path of the numerical values. Support data tree 316-1 has three paths that have a total score of 1 at the leaves. The three paths each start at the root and are shown as data paths 336, 338, and 340. Starting at the root node, each of the data paths 336, 338, and 340 have a score of 1. For example, data path 336 has a score that can be calculated by adding 0+0+0+1=1, wherein the first 0 corresponds to the value of the root node.

As described herein, a rule can be developed to choose a desired data path to remove when there is a tie for the lowest total score. The rule determined in this example is that the path furthest to the right side of the tree will be the data path to remove. Data path 336 is removed from the support data tree 316-1 since it is the path furthest to the right of the support data tree 316-1 with the lowest total score. The removal of data path 336 from the support data tree 316-1 results in a support data tree 316-2.

As described herein, after data path 336 is removed from support data tree 316-1, it results in support data tree 316-2. After the removal of data path 336, there can be an evaluation of each of the number of nodes within the support data tree to calculate a numerical value for each node within the support data tree 316-2. In some cases the numerical values for one or more of the number of nodes can change. For example, the numerical value for node 317-1 within the support data tree 316-1 before the removal of data path 336 was 0. In the same example, after the removal of data path 336, the numerical value for node 317-2 is 2. The numerical value of 2 can be calculated for 317-2 from the corresponding nodes from the data set 312 for the location of node 317-2 by utilizing an equation (e.g., Equation 1, Equation 2, etc.).

A second data path can be removed from support data tree 316-2. As described herein, data path 338 and data path 340 each still have a numerical value of 1. Utilizing the same rule as described herein for determining a data path to remove when there are multiple data paths with the lowest numerical value, data path 338 is determined to be the furthest data path to the right of the support data tree 316-2. Thus, data path 338 is removed from the support data tree.

As described herein, after data path 338 is removed from support data tree 316-2, it results in support data tree 316-3. After the removal of data path 338, there can be an evaluation of each of the number of nodes within the support data tree to calculate a numerical value for each node within the support data tree 316-3. In support data tree 316-3 the data path 340 has the lowest numerical value of 1. Thus, data path 340 is removed from support data tree 316-3. After data path 340 is removed, support data tree 316-4 is created.

Support data tree 316-4 can be evaluated after the removal of data path 340 and numerical values are calculated for each of the nodes within support data tree 316-4. Support data tree 316-4 has a data path 342 that has the lowest overall numerical value. Data path 342 has a value equal to 2 (e.g., 0+0+2=2). This is the lowest value compared to the remaining two data paths that equal 4 and 6 respectively. Data path 342 is removed from the support data tree 316-4 and after removal of the data path 342, the support data tree 316-5 is created and evaluated.

The numerical values for each of the remaining nodes are calculated for support data tree 316-5. Support data tree 316-5 has two remaining data paths. As described herein, the starting path for the support data tree (e.g., 316-1, 316-2, . . . , 316-5) includes a starting point. The starting point for 316-5 is the root node and node 319-2. As described herein, the starting point can have a numerical value of 0. In this example, the root node has a numerical value of 0 and node 319-2 has a numerical value of 0. Data path 344 is removed since it has a total numerical value of that is less than (e.g., 0+0+2+2=4) the other remaining data path 316-6. Thus, data path 344 is removed from the support data tree 316-5 and the remaining data path 316-6 is the final remaining data path.

Data path 316-6 can be the desired data path as described herein with reference to FIG. 1. For example, data path 316-6 can be a desired principle component of the data set 312.

FIG. 3 can be an example illustration of utilizing Equation 1 below. Equation 1 can be utilized N number of times, wherein a single data path can be removed for each of the N number of times. Thus, N can equal the desired number of data paths to be removed.

For the following equations I₀ can be a starting point for the number of data paths (e.g., node 222-1, etc.). In addition, T can equal a rooted data set (e.g., data set 312, etc.).

Equation 1 can be utilized to calculate a weight for each of the number of data paths as described herein. For example, Equation 1 can be utilized to calculate the numerical value for each of the number of data paths.

$${\sum }_{v ∈ ℒ} {w}_{i} ( v ) \qquad Equation 1$$

Equation 1 can be considered a weight function (wᵢ). The weight function can be defined as Equation 2. Within equation 2, v can denote a node and t can denote a data tree within the data set (T).

$${w}_{n - i} ( v ) \{ \begin{matrix}\begin{matrix}0 if v ∈ {l}_{0} or v belongs to at least 2 \\ different tree lines in {L}_{i - 1} ( T ) ; otherwise\end{matrix} \\ {\sum }_{t ∈ T} δ ( v , t )\end{matrix} \qquad Equation 2$$

The delta function (e.g., δ(ν, t) can be equal to 1 when t∈T. If ν∉T, then the delta function can be equal to 0. In Equation 2, t ∈T can represent when a data tree (t) is an element of the rooted tree data set (T). In addition, in Equation 2, ν can be a node within the support data tree. Furthermore, l₀ can be a chosen starting point for the number of data paths. For example, l₀ can be the root node of the support data tree. Thus, ν∈l₀ can be when a node (ν) is an element of the starting point (l₀). Lᵢ₋₁ (T) can be the remaining set of data paths after the removal at step i. Step i can be a particular iteration and/or removal step.

The weight function can be utilized to calculate a numerical value (e.g., weight) for each of the number of nodes within the support data tree. As described further herein, after each evaluation and determination of the number of numerical values for each of the number of nodes, a data path with the lowest sum of numerical values (e.g., weights) can be removed from the support data tree.

The weight function can be performed a predetermined number of iterations (e.g., N number of times). The predetermined number of iterations can be determined by how many data paths the user desires to remove. The number of iterations can be determined based on a projected amount of noise (e.g., data not desired) within the support data tree. For example, it can be determined that for a particular support data tree 10 iterations of removing a data path will result in a simplified version of the support data tree, wherein the simplified version can be utilized for a desired task. Other considerations when determining the number of iterations can include a determination of how many iterations can eliminate a proper amount of noise, but keeps desired structural trends of the support data tree and/or data set. The desired structural trends and amount of noise can be determined based upon the type of data set that is being utilized.

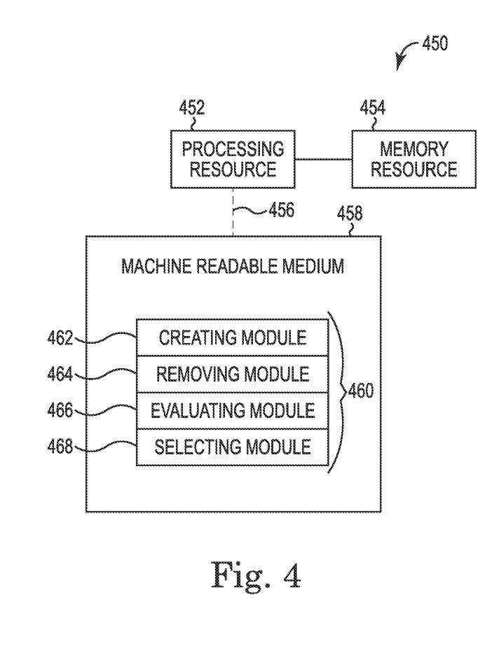

FIG. 4 is a diagram illustrating an example of a computing device 450 according to the present disclosure. The computing device 450 can utilize software, hardware, firmware, and/or logic to determine a number of node paths to remove over a number of iterations based on a node path value. The computing device 450 can include a computing device configured to perform the functions of the method described in FIG. 1.

The computing device 450 can be any combination of hardware and program instructions configured to select a desired data path. The hardware, for example can include one or more processing resources 452, machine readable medium (MRM) 458 (e.g., CRM, database, etc.). The program instructions (e.g., machine-readable instructions (MRI) 460) can include instructions stored on the MRM 458 and executable by the processing resources 452 to implement a desired function (e.g., select a desired node path, calculate a value for each of a number of nodes within a data tree, etc.).

MRM 458 can be in communication with a number of processing resources of more or fewer than 452. The processing resources 452 can be in communication with a tangible non-transitory MRM 458 storing a set of MRI 460 executable by one or more of the processing resources 452, as described herein. The MRI 460 can also be stored in remote memory managed by a server and represent an installation package that can be downloaded, installed, and executed. The computing device 450 can include memory resources 454, and the processing resources 452 can be coupled to the memory resources 454.

Processing resources 452 can execute MRI 460 that can be stored on an internal or external non-transitory MRM 458. The processing resources 452 can execute MRI 460 to perform various functions, including the functions described in FIG. 1, FIG. 2, and FIG. 3. For example, the processing resources 452 can execute MRI 460 to remove a number of paths from the support data tree based on the first number of evaluations.

The MRI 460 can include a number of modules 462, 464, 466, 468. The number of modules 462, 464, 466, 468 can include MRI 460 that when executed by the processing resources 452 can perform a number of functions.

The number of modules 462, 464, 466, 468 can be sub-modules of other modules. For example, a evaluating module 466 and the selecting module 468 can be sub-modules and/or contained within the same computing device 450. In another example, the number of modules 462, 464, 466, 468 can comprise individual modules on separate and distinct computing devices.

A creating module 462 can include MRI 460 that when executed by the processing resources 452 can perform a number of functions (e.g., creating a support data tree structure from a number of data trees within a data set, etc.). The creating module 462 can create a support data tree from a number of data trees within a data set as described herein in reference to FIG. 1, FIG. 2, and FIG. 3. For example, creating module 462 can receive a data set including a number of rooted data trees and create a support data tree.

A removing module 464 can include MRI 460 that when executed by the processing resources 452 can perform a number of functions (e.g., remove a data path from the support data tree, etc.). The removing module 464 can determine a data path with a lowest numerical value (e.g., weight) and remove the data path from the support data tree.

An evaluation module 466 can include MRI 460 that when executed by the processing resources 452 can perform a number of functions. The evaluation module 466 can evaluate each of the number of nodes within the support data tree and determine a number of numerical values (e.g., weights). For example, the evaluation module 466 can utilize Equation 1 and Equation 2 as described herein to determine a numerical value for each of the number of nodes within the support data tree.

A selecting module 468 can include MRI 460 that when executed by the processing resources 452 can perform a number of functions. The selecting module 468 can select the desired data paths. For example, the selecting module 468 can determine when the desired number of iterations have been completed and determine that the remaining data path is the desired data path.

A non-transitory MRM 458, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of computer-readable media.

The non-transitory MRM 458 can be integral, or communicatively coupled, to a computing device, in a wired and/or a wireless manner. For example, the non-transitory MRM 458 can be an internal memory, a portable memory, a portable disk, or a memory associated with another computing resource (e.g., enabling MRIs to be transferred and/or executed across a network such as the Internet).

The MRM 458 can be in communication with the processing resources 452 via a communication path 456. The communication path 456 can be local or remote to a machine (e.g., a computer) associated with the processing resources 452. Examples of a local communication path 456 can include an electronic bus internal to a machine (e.g., a computer) where the MRM 458 is one of volatile, non-volatile, fixed, and/or removable storage medium in communication with the processing resources 452 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 456 can be such that the MRM 458 is remote from the processing resources (e.g., 452), such as in a network connection between the MRM 458 and the processing resources (e.g., 452). That is, the communication path 456 can be a network connection. Examples of such a network connection can include a local area network (LAN), wide area network (WAN), personal area network (PAN), and the Internet, among others. In such examples, the MRM 458 can be associated with a first computing device and the processing resources 452 can be associated with a second computing device (e.g., a Java® server). For example, a processing resource 452 can be in communication with a MRM 458, wherein the MRM 458 includes a set of instructions and wherein the processing resource 452 is designed to carry out the set of instructions.

The processing resources 452 coupled to the memory resources 454 can execute MRI 460 to create a support data tree comprising a number of nodes that represent a number of corresponding nodes from a data set. The processing resources 452 coupled to the memory resources 454 can execute MRI 460 to determine a first value for each of the number of nodes from the support data tree. The processing resources 452 coupled to the memory resources 454 can also execute MRI 460 to remove a node path comprising a number of nodes based on the first value. The processing resources 452 coupled to the memory resources 454 can also execute MRI 460 to determine a second value for each of the number of remaining nodes from the support data tree. Furthermore, the processing resources 452 coupled to the memory resources 454 can execute MRI 460 to select a desired node path based on the second value for each of the number of remaining nodes.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor.

As used herein, “a” or “a number of” something can refer to one or more such things. For example, “a number of nodes” can refer to one or more nodes.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A method for selecting data paths, comprising:
utilizing a processor to execute instructions located on a non-transitory medium for:
creating a support data tree structure from a number of data trees within a data set;
removing a number of paths from the support data tree based on a number of evaluations of each of a number of nodes within the support data tree; and
selecting a number of desired paths based on a desired number of removed paths and an associated number of evaluations of the support data tree.

2. The method of claim 1, wherein creating the support data tree comprises determining a corresponding root node within the data set and creating a node for the support data tree that corresponds to each node within the data set on a lower level than the corresponding root node.

3. The method of claim 1, wherein selecting the number of desired paths comprises selecting a remaining path, wherein the remaining path is a result of a series of removals of a number of paths from the support data tree and subsequent evaluations of a number of remaining paths of the support data tree.

4. The method of claim 1, wherein removing the number of paths includes removing at least one of the number of nodes from the support data tree.

5. The method of claim 4, wherein removing the at least one of the number of nodes from the support data tree results in changing an evaluation for a remaining number of nodes within the support data tree.

6. The method of claim 1, wherein the number of paths that are removed from the support data tree have a least number of corresponding paths within the data set.

7. A non-transitory computer-readable medium storing a set of instructions executable by a processor to cause a computer to:
create a support data tree structure from a number of data trees of a data set, wherein the support data tree comprises a number of nodes that correspond to a node location within each of the number of data trees;
calculate a value for each of the number of nodes;
determine a number of node paths to remove over a number of iterations based on a node path value, wherein the node path value is based on the calculated value of each node within each of the number of node paths; and
select a plurality of remaining node paths based on the number of iterations.

8. The medium of claim 7, wherein the number of node paths to remove from the support data tree include a least frequent node path within the data set for each respective iteration.

9. The medium of claim 7, further comprising a set of instructions to re-evaluate each of a number of remaining corresponding nodes over each of the number of iterations.

10. The medium of claim 7, wherein the value for a particular one of the number of nodes changes based on a removed node path after a particular one of the number of iterations.

11. The medium of claim 7, wherein the node location comprises a particular data object.

12. A system for selecting a number of data paths, comprising:
a memory resource;
a processing resource coupled to the memory resource to implement:
a creating module to create a support data tree comprising a number of nodes that represent a number of corresponding nodes from a data set;
an evaluating module to determine a first value for each of the number of nodes from the support data tree;
a removing module to remove a node path based on the first value for each of the number of nodes within the node path;
the evaluating module to determine a second value for each of a number of remaining nodes from the support data tree; and
a selecting module to select a number of desired node paths based on the second value for each of the number of remaining nodes.

13. The computing system of claim 12, wherein the number of corresponding nodes from the data set are selected based on a predetermined root node.

14. The computing system of claim 12, wherein selecting the desired node paths comprises removing a number of node paths to leave a single node path for selection.

15. The computing system of claim 14, wherein removing the number of node paths comprises an evaluation after each removal of a node path to determine a value of the number of remaining nodes from the support data tree.
